(19) United States
(12) Patent Application Publication
(10) Pub. No.: US 2026/0149670 A1
(43) Pub. Date: May 28, 2026

(54) ADOPTING PROPORTIONAL INCREASE FOR OPTIMIZING BANDWIDTH UTILIZATION

(71) Applicant: Advanced Micro Devices, Inc., Santa Clara, CA (US)

(72) Inventors: Rong PAN, Santa Clara, CA (US); Yanfang LE, Santa Clara, CA (US); Vipin JAIN, Santa Clara, CA (US); Peter NEWMAN, Santa Clara, CA (US)

(21) Appl. No.: 18/957,498

(22) Filed: Nov. 22, 2024

(51) Int. Cl. H04L 47/32; H04L 47/283

(52) U.S. Cl. CPC H04L 47/323; H04L 47/283

(57) ABSTRACT

A sending networking device includes one or more processors, and memory storing one or more software applications which, when executed by any combination of the one or more processors performs an operation. The operation includes determining whether an explicit congestion notification (ECN) is marked on an acknowledgement (ACK), determining whether a measured delay is less than a target delay, and upon determining that the ECN is not marked and that the measured delay is less than the target delay, proportionally increasing a transmission parameter based on a difference between the target delay and the measured delay.

### TECHNICAL FIELD

Examples of the present disclosure generally relate to congestion management, and in particular to adopting proportional increase for optimizing bandwidth utilization.

### BACKGROUND

Devices in data centers are connected through Ethernet based high speed networking devices such as network interfaces, switches, and routers. These networking devices often employ congestion management mechanisms, such as congestion control and load balancing, to enhance network performance. While existing methods of congestion management, such Data Center Quantized Congestion Notification (DCQCN), aim to alleviate congestion levels and avoid congestion spreading, they may struggle in large-scale environments, leading to slow network performance and excessive traffic delays. As data center applications, such as emerging artificial intelligence (AI) and machine learning (ML) training networks, continue to demand higher utilization of their network links, bandwidth utilization optimization in the context of congestion management has become a key consideration.

Thus, there is a need in the art for improving bandwidth utilization of the network links without causing congestion.

### SUMMARY

Systems, methods, and devices are described for adopting proportional increase for optimizing bandwidth utilization.

According to one aspect of the present disclosure, a sending networking device includes one or more processors, and memory storing one or more software applications which, when executed by any combination of the one or more processors performs an operation, the operation comprising determining whether an explicit congestion notification (ECN) is marked on an acknowledgement (ACK) received by the sending networking device, the ACK being associated with a packet transmitted from the sending networking device; determining whether a measured delay of the packet is less than a first threshold; and upon determining that the ECN is not marked and that the measured delay is less than the first threshold, proportionally increasing a transmission parameter based on a difference between the first threshold and the measured delay.

According to another aspect of the present disclosure, a method includes determining whether an explicit congestion notification (ECN) is marked on an acknowledgement (ACK) received by a sending networking device, the ACK being associated with a packet transmitted from the sending networking device; determining whether a measured delay of the packet is less than a first threshold; and upon determining that the ECN is not marked and that the measured delay is less than the first threshold, proportionally increasing a transmission parameter based on a difference between the first threshold and the measured delay.

According to yet another aspect of the present disclosure, a system includes a receiving networking device; and a sending networking device configured to use a multipath connection to transmit data over a network to the receiving networking device, wherein the sending networking device is configured to: determine whether an explicit congestion notification (ECN) is marked on an acknowledgement (ACK) received by the sending networking device, the ACK being associated with a packet transmitted from the sending networking device; determine whether a measured delay associated with the packet is less than a target delay; and upon determining that the ECN is not marked and that the measured delay is less than the target delay, proportionally increase a transmission parameter based on a difference between the target delay and the measured delay; wherein the target delay is associated with an average Round Trip Time (RTT) of packets transmitted between the sending networking device and the receiving networking device.

### BRIEF DESCRIPTION OF DRAWINGS

So that the manner in which the above recited features can be understood in detail, a more particular description, briefly summarized above, may be had by reference to example embodiments, some of which are illustrated in the appended drawings. It is to be noted, however, that the appended drawings illustrate only typical example embodiments and are therefore not to be considered limiting of its scope.

FIG. 1 illustrates a block diagram of a communication system, in accordance with an example embodiment of the present disclosure.

FIG. 2 illustrates a schematic diagram showing various regions of a queue, in accordance with an example embodiment of the present disclosure.

FIG. 3 is a flowchart of a method performed by a sending networking device, in accordance with an example embodiment of the present disclosure.

FIG. 4 is a flowchart of a method performed by a sending networking device, in accordance with an example embodiment of the present disclosure.

FIG. 5 illustrates a block diagram of a host and a NIC, in accordance with an example embodiment of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe congestion control methods to increase data traffic, such as a flow's transmission rate or a congestion control window size (e.g., the number of bytes allowed in a round trip time), from a sender to a receiver when extra bandwidth becomes available. According to an example method, a sender (e.g., a sending networking device) can leverage a congestion signal (e.g., an Explicit Congestion Notification (ECN) marking on a received packet) and a measured delay to optimize bandwidth utilization. For example, upon determining that a received packet (e.g., a response packet or an acknowledgement (ACK) of a packet transmitted from the sender) from a receiver is not marked with an ECN and that a measured delay of the packet associated with the ACK is less than a target delay (e.g., a delay threshold), the sender proportionally increases a transmission parameter (e.g., a flow's transmission rate or a congestion window size) based on the difference between the target delay and the measured delay, for example, per Round Trip Time (RTT).

The absence of the ECN marking on the received packet indicates that the path through which the packet was transmitted (e.g., from the sender) is not congested. The measured delay is reflective of the queueing delay along the path. When the difference between the target delay and the measured delay is large, the sender takes bigger steps to increase the transmission rate or the congestion window size to prevent under-utilization of the path's bandwidth. When the difference becomes smaller, for example, as the current measured delay approaches the target delay threshold, the amount of increase becomes smaller to avoid causing congestion. This method allows for efficient utilization of available bandwidth with precision and speed and without causing extra congestion to the network.

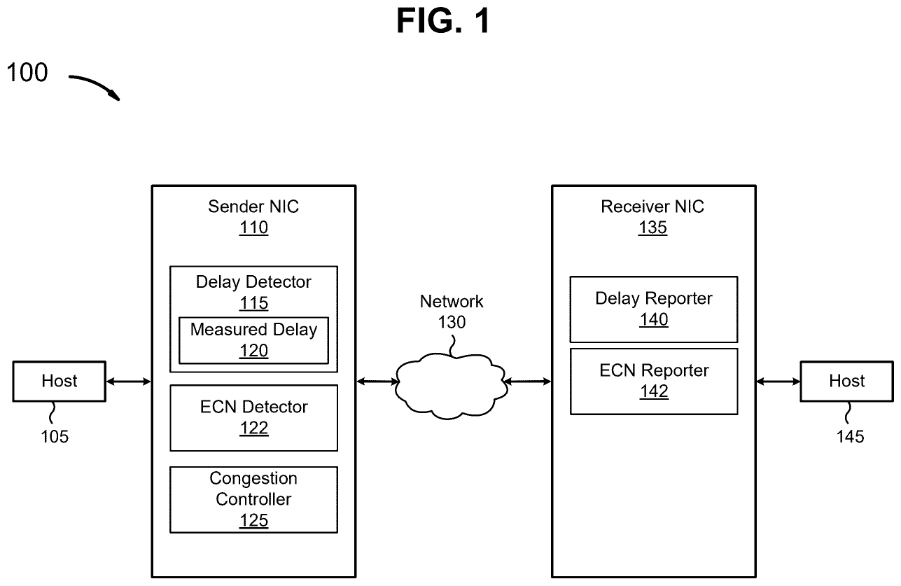

FIG. 1 illustrates a block diagram of a communication system 100, according to an example embodiment of the present disclosure. The system 100 includes a sender NIC 110 (e.g., a sending networking device) connected to a host 105 and a receiver NIC 135 (e.g., a receiving networking device) connected to a host 145. In one embodiment, the sender NIC 110 can be part of the host 105, and the receiver NIC 135 can be part of the host 145. In one embodiment, the sender NIC 110 can be one endpoint and the receiver NIC 135 can be another endpoint which are connected by a network 130. The network 130 can include a plurality of switches or other types of networking devices (not explicitly shown).

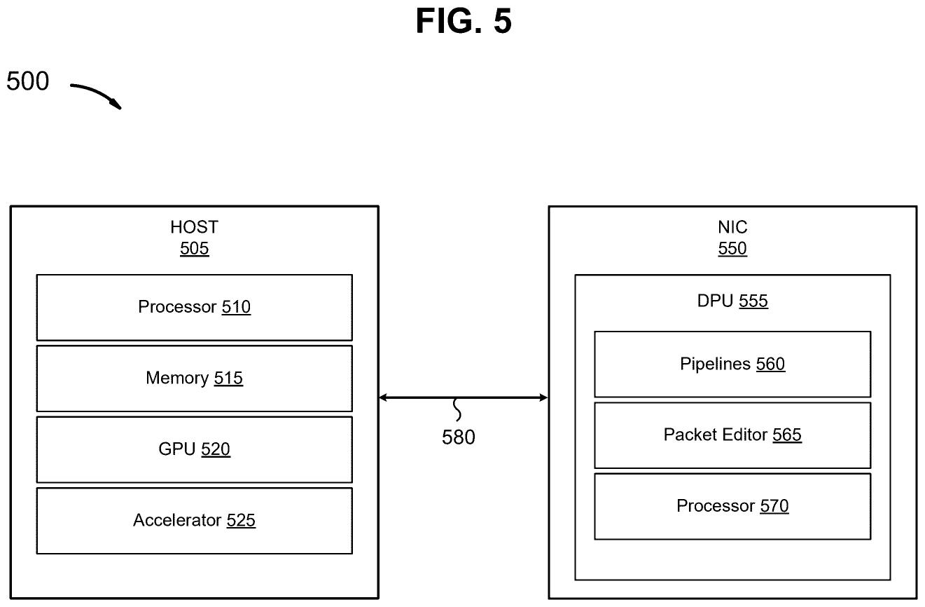

In one embodiment, the sender NIC 110 and the receiver NIC 135 are SmartNICs. However, the embodiments herein at not limited to using NICs, can be implemented on any endpoints of a network. More embodiments of the hosts 105, 145 and the NICs 110, 135 are provided in FIG. 5.

In FIG. 1, the sender NIC 110 includes a delay detector 115, an ECN detector 122, and a congestion controller 125. These components can be hardware (e.g., hardened or programmable logic), firmware, software applications, or combinations thereof. In any case, the functions of the delay detector 115, the ECN detector 122, and the congestion controller 125 can be executed using circuitry on the sender NIC 110.

The delay detector 115 can detect (or measure) delays in the network 130 or at the receiver NIC 135. For example, the receiver NIC 135 can be considered part of the network. That is, in one embodiment, the interfaces between the NIC 110 and the host 105, and between the NIC 135 and the host 145 can be the end of the network 130. In one embodiment, a measured delay is based on an actual delay experienced by a packet from the sender NIC 110 subtracted by a baseline propagation delay, where the baseline propagation delay is based on the specific path and the number of switches the packet travels through in the network 130 when there is no network congestion (or when the network 130 is an uncongested network). In one embodiment, the measured delay can be obtained by subtracting an actual RTT (e.g., a measured RTT) of a packet by a baseline RTT. RTT is the latency that a packet experienced going through a network. In some examples, an actual RTT can be based on the difference between a packet transmit time from a sender and an ACK receipt time at the sender. In some examples, a baseline RTT can represent a lowest RTT value in an uncongested network (e.g., when there is no network congestion). The baseline RTT can be determined by the sender NIC 110.

The ECN detector 122 can detect whether a received packet (e.g., a response packet or an ACK) is marked with an ECN. An ECN marking indicates that there is congestion on a path in the network 130, which can include congestion at the receiver NIC 135 itself. ECN is an extension to the Internet Protocol and to the Transmission Control Protocol that allows end-to-end notification of network congestion without dropping packets. When a switch in the network 130 detects congestion, it can mark a packet that is sent to the receiver NIC 135. The receiver NIC 135 can then identify which path (e.g., among a multipath connection) the packet was sent on and send a report to the sender NIC 110 through a response packet or an ACK. In one embodiment, the ECN marking can be a one-bit indicator that a switch in the network 130 marks on the packet. In another embodiment, the ECN marking can be a multi-bit indicator indicating congestion at multiple switches in the network 130.

In one embodiment, the sender NIC 110 can use multiple paths (e.g., a multipath connection) to transmit data to the receiver NIC 135. That is, the sender NIC 110 can assign packets to different paths (which can use different switches in the network 130) to transmit packets to the receiver NIC 135. In one embodiment, the delay detector 115 can detect a measured delay 120 for each packet. For example, for each packet transmitted from the sender NIC 110, the delay detector 115 measures an actual delay of the packet and subtracts the actual delay experienced by the packet by a baseline propagation delay, where the baseline propagation delay is based on the specific path and the number of switches the packet travels through in the network 130 when there is no network congestion. Hence, the measured delay 120 is reflective of the total queueing delay in the network 130.

In one embodiment, if the ECN is not marked and if the measured delay 120 is less than a target delay (e.g., a delay threshold), the sender NIC 110 can use the congestion controller 125 to perform a proportional increase to a transmission parameter (e.g., a flow's transmission rate or a congestion window size) per RTT based on the difference between the measured delay and the target delay to increase data traffic from the sender NIC 110 to the receiver NIC 135.

In one embodiment, if the ECN is not marked and if the measured delay 120 is substantially greater (e.g., at least two times greater) than the target delay, instead of performing rate limiting or window management to reduce the amount of data traffic the sender NIC 110 transmits to the receiver NIC 135, the sender NIC 110 can use the congestion controller 125 to perform an additive increase to a transmission parameter (e.g., a flow's transmission rate or a congestion window size) by a configurable amount per RTT to increase data traffic from the sender NIC 110 to the receiver NIC 135.

The embodiments herein are not limited to any particular congestion algorithm for the congestion controller 125, and can be used with any suitable algorithm that proportionally or additively increases data traffic in a single-path or multipath connection.

The receiver NIC 135 includes a delay reporter 140 and an ECN reporter 142. These components can be hardware (e.g., hardened or programmable logic), firmware, software applications, or combinations thereof. In any case, the functions of delay reporter 140 and the ECN reporter 142 can be executed using circuitry on the receiver NIC 135.

The delay reporter 140 can indicate a delay associated with a path along which a packet traveled from the sender NIC 110 to the receiver NIC 135, and report the delay back to the sender NIC 110.

The ECN reporter 142 can provide notifications to the sender NIC 110 when there is congestion on a path in the network 130, which can include congestion at the receiver NIC 135 itself. When one or more switches in the network 130 detect congestion, they can mark a packet (e.g., using one or more bits) that is sent to the receiver NIC 135. The receiver NIC 135 can then identify which path (e.g., in a multipath connection) the packet was sent on and send a report to the sender NIC 110 (e.g., through a response packet or an ACK). In this manner, the ECN detector 122 can be alerted to congestion. If the ECN reporter 142 does not report an ECN marking on a packet, then the ECN detector 122 determines that the path through which the packet was transmitted is not congested.

Additionally, the receiver NIC 135 can detect internal congestion, such as when packets are being buffered at the interface between the receiver NIC 135 and the host 145 (e.g., a PCIe interface or a host facing interface). When the buffer reaches a threshold and a new packet arrives from the network 130, the receiver NIC 135 can use ECN (or any suitable congestion technique) to inform the sender NIC 110. Thus, even though there may not be congestion in the network devices in the network 130, the ECN reporter 142 can still indicate congestion associated with a particular path when the congestion is at the receiver NIC 135.

Tracking ECN markings on the packets using the information provided by the ECN reporter 142 on the receiver NIC 135 helps the sender NIC 110 to identify congestion on the network 130 or at the receiver NIC 135. For example, when a certain threshold number of packets are marked with ECN, the sender NIC 110 determines that the congestion is due to congestion on the network as a whole or at the receiver, and in response, activates the congestion controller 125 to limit the data being sent to the receiver NIC 135. In contrast, before the threshold is reached, the sender NIC 110 may send more traffic on non-congested paths of the multipath connection while avoiding the congested paths, thereby maintaining the same data rate or throughput.

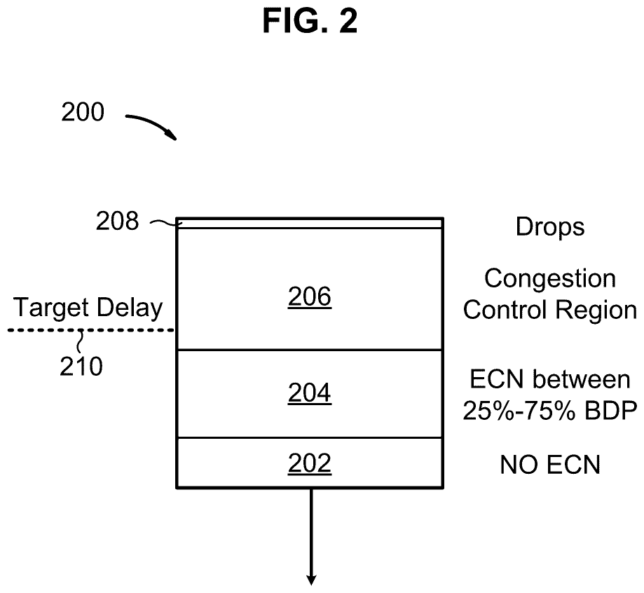

FIG. 2 illustrates a schematic diagram showing various regions of a queue, according to one example embodiment of the present disclosure. In the present embodiment, a queue 200 includes regions 202, 204, 206, and 208. In region 202, the network is not congested and the packets are not ECN marked. In region 204, the network is lightly congested, and the packets may or may not be ECN marked as ECN marking is probabilistic. In the present embodiment, as shown in region 204, the ECN marking threshold is between 25% and 75% of Bandwidth Delay Product (BDP). In region 206, the network is likely congested, and the packets are likely ECN marked. In one embodiment, the target delay 210 is associated with an average delay (e.g., an average RTT) of all packets transmitted between the sending networking device and the receiving networking device. In region 208, the network is congested and the queue 200 is full. In region 208, packet drops are likely to occur. It should be understood that the queue 200 can be in one or more of a sending networking device, a network switch, and a receiving networking device.

According embodiments of the present disclosure, a congestion controller can increase (e.g., proportionally or additively) data traffic from a sending networking device to a receiving networking device per RTT based on a congestion signal (e.g., the absence of an ECN marking on a packet) and a measured delay. Based on the ECN marking (or the absence thereof) and measured delay, the congestion controller can handle the following four scenarios:

In the first scenario, a received packet (e.g., a response packet or an ACK of a packet sent from the sender) is not ECN marked, and the measured delay of the packet transmitted by the sender (e.g., associated with the received packet) is less than the target delay 210. In this scenario, the congestion controller increases data traffic from the sending networking device (e.g., the sender NIC 110 in FIG. 1) to the receiving networking device (e.g., the receiver NIC 135 in FIG. 1) by increasing a transmission parameter (e.g., a flow's transmission rate or a congestion window size) proportionally based on how far the measured delay is from the target delay 210 per RTT. For example, when the ECN is not marked and when the congestion window is not at the maximum value (e.g., due to a prior congestion episode), the congestion controller can proportionally increase the transmission rate or congestion window size to maximize bandwidth utilization.

In the second scenario, a received packet (e.g., a response packet or an ACK of a packet sent from the sender) is ECN marked, but the measured delay of the packet transmitted by the sender (e.g., associated with the received packet) is still less than the target delay 210. In this scenario, the network is slightly congested. The congestion controller can choose to switch paths based on probabilistic ECN marking while keeping the congestion window intact to allow packets to flow to other paths.

In the third scenario, as the network congestion continues to increase, a majority of the received packets are ECN marked and the measured delay exceeds the target delay 210. In this scenario, it is likely that there is network wide congestion, and congestion control will be triggered. The congestion controller cuts the flow's transmission rate or congestion window size multiplicatively. When the measured delay is much greater than the target delay 210, the congestion controller can use additional congestion signals (e.g., achieved BDP, total acknowledged bytes in one base RTT, etc.) to quickly converge, for example, in heavy in-cast scenarios.

In the fourth scenario, a received packet (e.g., a response packet or an ACK of a packet sent from the sender) is not ECN marked, and the measured delay of the packet transmitted by the sender (e.g., associated with the received packet) is substantially greater than (e.g., at least two times greater than) the target delay 210. This is a scenario that may occur when the congestion goes away (e.g., after a congestion control episode), and the packet that has experienced a long queueing delay will not be ECN marked as no queue is built up behind it. That is, the packet may have been in the queue 200 for a long time because of congestion (thus contributing to a large delay, e.g., twice the target delay 210) but the congestion may be gone by the time the packet reaches the front of the queue, and thus, the switch does not mark it with an ECN. In this scenario, the congestion controller increases data traffic from the sending networking device (e.g., the sender NIC 110 in FIG. 1) to the receiving networking device (e.g., the receiver NIC 135 in FIG. 1) by increasing a transmission parameter (e.g., a flow's transmission rate or a congestion window size) additively by a configurable amount per RTT to avoid starving the link.

It is noted that according to existing congestion control techniques, when a measured delay is greater than the target delay, the congestion controller treats the situation as a network wide congestion, and preforms congestion control to limit data traffic from the sender to the receiver. In contrast, according to embodiments of the present disclosure, upon determining that a received packet is not ECN marked, and the measured delay is substantially greater (e.g., at least two times greater) than the target delay, the congestion controller increases the data traffic additively per RTT. It should be understood that, in some embodiments, the measured delay can be about 1.5 times greater than the target delay, and the congestion controller can additively increase the data traffic per RTT.

In some embodiments of the present disclosure, a packet is marked with an ECN at the egress (e.g., egress-marked ECN), when the packet exits a congested queue. As an example, although a packet may not have experienced queueing delay, it can nevertheless be marked with an ECN which indicates that the queue behind it is building up. Hence, an egress-marked ECN can provide the earliest congestion signal that is much faster than a congestion signal, for example, indicated by an RTT or a change in RTT.

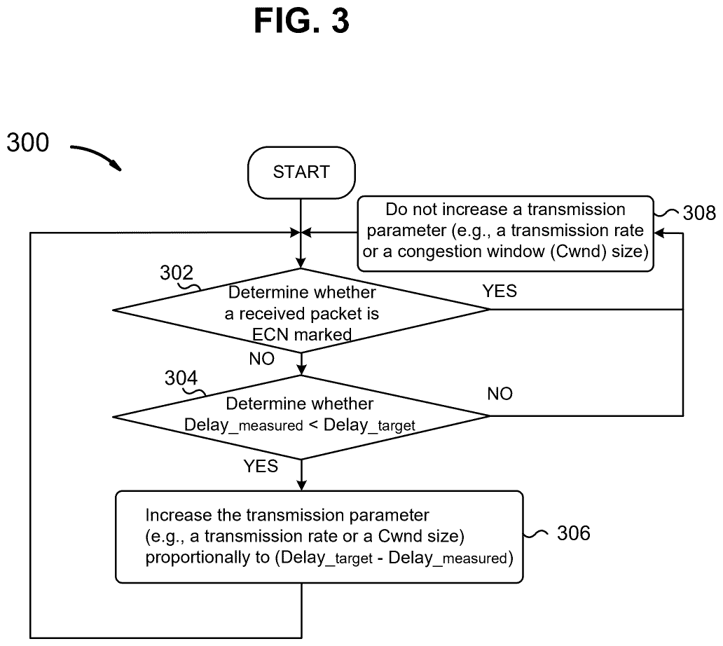

FIG. 3 is a flowchart of a method 300 performed by a sending networking device (e.g., a sender NIC), according to an example embodiment of the present disclosure.

At block 302, the sender NIC determines whether a received packet (e.g., a response packet or an ACK of a packet sent from the sender) is marked with an ECN (e.g., ECN marked). If an ECN detector of the sender NIC determines that the received packet is marked with an ECN, the ECN marking indicates that the path through which the packet (e.g., transmitted from the sender and associated with the received packet) is transmitted is congested. Then, the flowchart proceeds from block 302 to block 308, where the sender NIC performs congestion control, for example, by not increasing (or by decreasing) data traffic (e.g., a transmission parameter such as a transmission rate or a congestion window size) from the sender to the receiver. If the ECN detector of the sender NIC determines that the received packet is not marked with an ECN, then the flowchart proceeds from block 302 to block 304.

At block 304, the sender NIC determines whether a measured delay of the packet (e.g., transmitted from the sender and associated with the received packet) is less than a target delay. In one embodiment, the measured delay is obtained by subtracting an actual delay experienced of the packet in the path by a baseline propagation delay of the path. For example, the measured delay can be obtained by subtracting an actual RTT (e.g., a measured RTT) of the packet by a baseline RTT.

The sender NIC compares the measured delay with the target delay (e.g., a delay threshold, such as the target delay 210 in FIG. 2). If the measured delay is less than the target delay (e.g., Delay_measured<Delay_target), then the flowchart proceeds from block 304 to block 306. Otherwise, the flowchart proceeds from block 304 to block 308.

At block 306, upon determining that the received packet is not marked with an ECN and that the measured delay of the packet is less than the target delay, the sender NIC recognizes this combination as the first scenario described above with reference to FIG. 2, and increases a transmission parameter (e.g., associated with the amount of data transmitted from the sender to the receiver) proportionally based on the difference between the target delay and the measured delay (e.g., Delay_target−Delay_measured).

In one example, in a window-based congestion control scheme, the sender NIC increases the congestion window size per RTT according to Equation (1):

$${Cwnd}_{2} = {Cwnd}_{1} + {α}_{Cwnd} \times ( {Delay}_{\_ target} - {Delay}_{\_ measured} ) \times \frac{{ACK}_{\_ bytes}}{{Cwnd}_{1}}$$

where:
Cwnd₁ can represent a current congestion window size,
Cwnd₂ can represent an updated congestion window size,
α_{Cwnd} can represent a window-based control parameter configured by the sender NIC,
Delay_target can represent a target delay (e.g., a delay threshold),
Delay__{measured} can represent a measured delay of a packet, and
ACK__{bytes} can represent a number of acknowledged bytes.

After an RTT, the accumulated acknowledged bytes should equal to the congestion window, Cwnd₁. In this way, after an RTT, the congestion window size (Cwnd₂) is proportionally increased by α_{Cwnd}×(Delay__{target}−Delay__{measured}). In one example, α_{Cwnd} can have a constant value. In one example, the value of α_{Cwnd} can be configurable based on the current measured delay.

In another example, in a rate-based congestion control scheme, the sender increases a flow's transmission rate per RTT according to Equation (2):

$${Rate}_{2} = {Rate}_{1} + {α}_{Rate} \times ( {Delay}_{\_ target} - {Delay}_{\_ measured} )$$

where:
Rate₁ can represent a current transmission rate,
Rate₂ can represent an updated transmission rate,
α_{Rate} can represent a rate-based control parameter configured by the sender NIC,
Delay__{target} can represent a target delay (e.g., a delay threshold), and
Delay__{measured} can represent a measured delay of a packet.

After an RTT, the transmission rate (Rate₂) is proportionally increased by α_{Rate}×(Delay__{target}−Delay__{measured}). In one example, α_{Rate} can have a constant value. In one example, the value of α_{Rate} can be configurable based on the current measured delay.

After block 306, the flowchart proceeds back to block 302 for the next iteration (e.g., the next RTT). As such, a feedback loop is formed to ensure that any available bandwidth is efficiently utilized. The present method can quickly and accurately increase a flow's transmission rate or congestion window size, since it utilizes the linear proportion of the difference between the measured delay and the target delay, which guides the crucial amount of adjustment to quickly utilize available bandwidth without causing congestion.

Referring back to block 304, if the sender NIC determines that the measured delay is equal to or above the delay threshold (e.g., Delay_measured>=Delay_target), then the flowchart proceeds from block 304 to block 308, where the sender NIC performs congestion control, for example, by not increasing (or by decreasing) data traffic from the sender to the receiver.

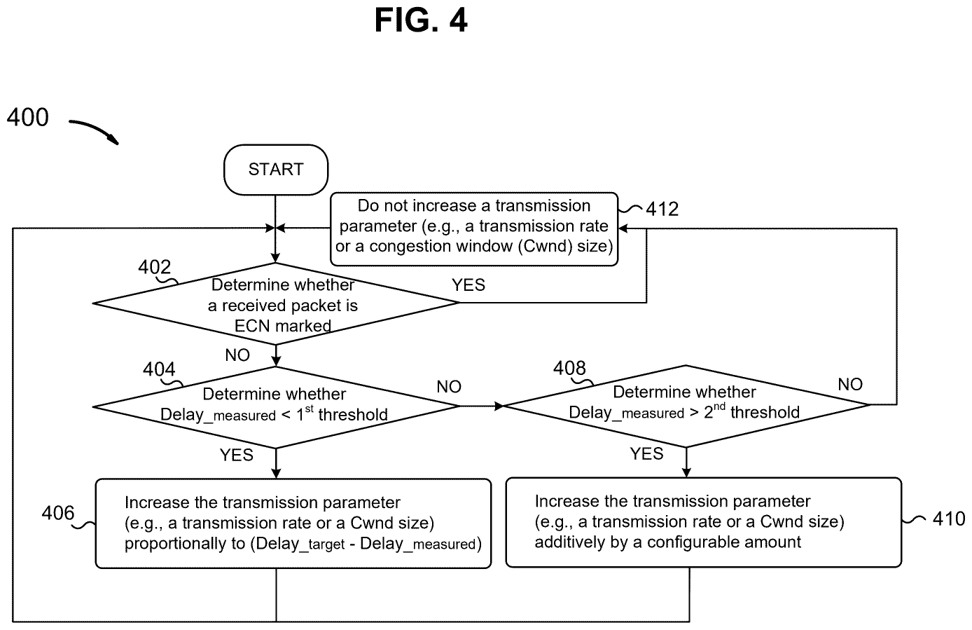

FIG. 4 is a flowchart of a method 400 performed by a sending networking device (e.g., a sender NIC), according to an example embodiment of the present disclosure.

At block 402, the sender NIC determines whether a received packet (e.g., a response packet or an ACK of a packet sent from the sender) is marked with an ECN (e.g., ECN marked). If an ECN detector of the sender NIC determines that the received packet is marked with an ECN, the ECN marking indicates that the path through which the packet (e.g., transmitted from the sender and associated with the received packet) is transmitted is congested. Then, the flowchart proceeds from block 402 to block 412, where the sender NIC performs congestion control, for example, by not increasing (or by decreasing) data traffic (e.g., a transmission parameter such as a transmission rate or a congestion window size) from the sender to the receiver. If the ECN detector of the sender NIC determines that the received packet is not marked with an ECN, then the flowchart proceeds from block 402 to block 404

At block 404, the sender NIC determines whether a measured delay of the packet (e.g., transmitted from the sender and associated with the received packet) is less than a first threshold. In one embodiment, the measured delay is obtained by subtracting an actual delay experienced of the packet in the path by a baseline propagation delay of the path. For example, the measured delay can be obtained by subtracting an actual RTT (e.g., a measured RTT) of the packet by a baseline RTT.

In one embodiment, the first threshold is the target delay 210 or Delay_target described with reference to FIGS. 2 and 3 above. If the measured delay is less than the first threshold (e.g., Delay_measured<Delay_target), then the flowchart proceeds from block 404 to block 406. Otherwise, the flowchart proceeds from block 404 to block 408.

At block 406, upon determining that the received packet is not marked with an ECN and that the measured delay of the packet (e.g., transmitted from the sender NIC and associated with the received packet) is less than the first threshold, the sender NIC recognizes this combination as the first scenario described above with reference to FIG. 2, and increases a transmission parameter (e.g., associated with the amount of data transmitted from the sender to the receiver) proportionally based on the difference between the measured delay and the first threshold (e.g., Delay_target−Delay_measured). For example, the transmission parameter can be proportionally increased according to Equation (1) or (2) above.

In the present embodiment, blocks 402, 404, and 406 are substantially similar to blocks 302, 304, and 306, respectively, in FIG. 3, the details of which are omitted for brevity.

After block 406, the flowchart proceeds back to block 402 for the next iteration (e.g., the next RTT). As such, a feedback loop is formed to ensure that any available bandwidth is efficiently utilized.

Referring back to block 404, if the sender NIC determines that the measured delay is not less than the first threshold (e.g., Delay_measured>=Delay_target), then the flowchart proceeds from block 404 to block 408.

At block 408, the sender NIC determines whether the measured delay is greater than a second threshold. In one embodiment, the second threshold is substantially greater than the first threshold. In one example, the first threshold is the target delay 210 or Delay_target described with reference to FIGS. 2 and 3 above. In one example, the second threshold is at least 1.5 times of the first threshold. In one example, the second threshold is at least two times of the first threshold.

If the sender NIC determines that the measured delay is greater than the second threshold (e.g., Delay_measured is greater than two times of the Delay_target), then the flowchart proceeds from block 408 to block 410. Otherwise, the flowchart proceeds from block 408 to block 412.

At block 410, upon determining that the received packet is not marked with an ECN and that the measured delay of the packet (e.g., transmitted from the sender NIC and associated with the received packet) is greater than the second threshold, the sender NIC recognizes this combination as the fourth scenario described above with reference to FIG. 2, and increases a transmission parameter (e.g., associated with the amount of data transmitted from the sender to the receiver) additively by a configurable amount. In this case, the sender NIC recognizes that the packet has experienced a long queueing delay (therefore the measured delay is high), but there is no queue built up behind the packet (therefore the ECN is not marked at the egress), for example, due to a prior congestion control episode. Thus, instead of limiting data traffic on the path according to conventional congestion control mechanisms, the sender NIC recognizes the above situation as an opportunity to increase data traffic to prevent link starvation and maintain high throughput and low latency.

In one example, in a window-based congestion control scheme, the sender NIC increases the congestion window size according to Equation (3):

$${Cwnd}_{2} = {Cwnd}_{1} + {β}_{Cwnd} \times \frac{{ACK}_{\_ bytes}}{{Cwnd}_{1}}$$

where:
Cwnd₁ can represent a current congestion window size,
Cwnd₂ can represent an updated congestion window size,
β_{Cwnd} can represent a window-based control parameter configured by the sender NIC, and
ACK__{bytes} can represent a number of acknowledged bytes.

After an RTT, the accumulated acknowledged bytes should equal to the congestion window, Cwnd₁. In this way, after an RTT, the congestion window size (Cwnd₂) is additively increased by a configurable amount, β_{Cwnd}. In one example, β_{Cwnd} can have a constant value. In one example, the value of β_{Cwnd} can be configurable based on the current measured delay.

In another example, in a rate-based congestion control scheme, the sender increases a flow's transmission rate according to Equation (4):

$${RATE}_{2} = {RATE}_{1} + {β}_{RATE}$$

where:
Rate₁ can represent a current transmission rate,
Rate₂ can represent an updated transmission rate,
β_{Rate} can represent a rate-based control parameter configured by the sender NIC.

After an RTT, the transmission rate (Rate₂) is additively increased by a configurable amount, β_{Rate}. In one example, β_{Rate} can have a constant value. In one example, the value of β_{Rate} can be configurable based on the current measured delay.

After block 410 the flowchart proceeds back to block 402 for the next iteration (e.g., the next RTT). As such, a feedback loop is formed to ensure that any available bandwidth is efficiently utilized.

Referring back to block 408, if the sender NIC determines that the measured delay is not greater than the second threshold (e.g., Delay_measured is greater than or equal to the target delay and less than or equal to two times of the target delay), then the flowchart proceeds from block 408 to block 412, where the sender NIC performs congestion control, for example, by not increasing (or by decreasing) data traffic (e.g., a transmission parameter such as a transmission rate or a congestion window size) from the sender to the receiver.

FIG. 5 illustrates a host 505 and a NIC 550 in a system 500, according to an example. The host 505 and the NIC 550 are communicatively coupled using a PCI connection 580. Moreover, the NIC 550 may be disposed in a form factor of the host, although this is not a requirement. Moreover, the embodiments herein are not limited to a NIC 550 and can be performed on other suitable networking devices.

The host 505 can be any computing system or device. For example, the host 505 can be a single computing device such as a server, or can be a computing system such as computing resources in a cloud or a cluster. In this example, the host 505 includes a processor 510 which represents any number of processors which each can include any number of processor cores. For example, the processor 510 can be a CPU.

The memory 515 can include volatile memory elements, non-volatile memory elements, and combinations thereof.

The host 505 can also include a graphics processing unit (GPU) 520 and/or an accelerator 525. The accelerator 525 can be a field programmable gate array, a system on a chip (SoC), an application specific integrated circuit (ASIC) and the like. In one embodiment, the NIC 550 can be used as part of an accelerator function that relies on GPUs or accelerators in multiple hosts. For example, the embodiments herein may be used as part of a high performance compute (HPC) task such as a machine learning (ML) or artificial intelligence (AI) application where large amounts of data are transmitted between GPUs/accelerators on multiple hosts using the NICs. Moreover, the embodiments herein can be used in applications that desire a lossless network (as is the case with many HPC tasks) or in lossy networks.

The NIC 550 includes a data processing unit (DPU) 555. The DPU 555 may process packets before they are forwarded to the host 505. The DPU 555 includes pipelines 560, a packet editor 565, and a processor 570. The DPU 555 may have two types of pipelines 560: networking pipelines which perform networking tasks such as combining packets that were subdivided to be compatible with a maximum transmission unit (MTU) or for dealing with one or more host operating systems, drivers, and/or message descriptor formats in host memory, and direct memory access (DMA) pipelines which perform memory reads and writes. A received packet is first processed by a networking pipeline before being processed by a DMA pipeline.

The packet editor 565 includes circuitry for editing the received packet. For example, the packet editor 565 can perform commands in order to prepare the packet to be processed by one of the pipelines 560.

The processor 570 can be a CPU or a specialized processor (e.g., a microprocessor) for performing particular networking tasks. Moreover, the processor 570 can be hardened logic, or can be implemented using programmable logic in the DPU 555. For example, the processor 570 in the DPU 555 may perform the tasks discussed above by the delay detector 115, ECN reporter 142, and/or congestion controller 125 in FIG. 1.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible embodiments of systems, methods, and computer program products according to various examples of the present invention. In this regard, each block in the flowchart or block diagrams may represent a module, segment, or portion of instructions, which comprises one or more executable instructions for implementing the specified logical function(s). In some alternative embodiments, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A sending networking device, comprising:
one or more processors; and
memory storing one or more software applications which, when executed by any combination of the one or more processors performs an operation, the operation comprising:
determining whether an explicit congestion notification (ECN) is marked on an acknowledgement (ACK) received by the sending networking device, the ACK being associated with a packet transmitted from the sending networking device;
determining whether a measured delay of the packet is less than a first threshold;
upon determining that the ECN is not marked and that the measured delay is less than the first threshold, proportionally increasing a transmission parameter based on a difference between the first threshold and the measured delay.

2. The sending networking device of claim 1, wherein the measured delay is based on a difference between an actual delay of the packet and a baseline delay of an uncongested network.

3. The sending networking device of claim 1, wherein the measured delay is based on a difference between a measured Round Trip Time (RTT) of the packet and a baseline RTT of an uncongested network.

4. The sending networking device of claim 1, wherein the transmission parameter is a congestion window size.

5. The sending networking device of claim 1, wherein the transmission parameter is a flow traffic's transmission rate.

6. The sending networking device of claim 1, wherein the first threshold is a target delay associated with an average Round Trip Time (RTT) of packets transmitted between the sending networking device and a receiving networking device.

7. The sending networking device of claim 1, wherein the operation further comprises:
upon determining that the ECN is not marked and that the measured delay is not less than the first threshold, determining whether the measured delay is greater than a second threshold, the second threshold being greater than the first threshold;
upon determining that the measured delay is greater than the second threshold, additively increasing the transmission parameter.

8. A method, comprising:
determining whether an explicit congestion notification (ECN) is marked on an acknowledgement (ACK) received by a sending networking device, the ACK being associated with a packet transmitted from the sending networking device;
determining whether a measured delay of the packet is less than a first threshold;
upon determining that the ECN is not marked and that the measured delay is less than the first threshold, proportionally increasing a transmission parameter based on a difference between the first threshold and the measured delay.

9. The method of claim 8, wherein the measured delay is based on a difference between an actual delay of the packet and a baseline delay of an uncongested network.

10. The method of claim 8, wherein the measured delay is based on a difference between a measured Round Trip Time (RTT) of the packet and a baseline RTT of an uncongested network.

11. The method of claim 8, wherein the transmission parameter is a congestion window size.

12. The method of claim 8, wherein the transmission parameter is a flow traffic's transmission rate.

13. The method of claim 8, wherein the first threshold is a target delay associated with an average Round Trip Time (RTT) of packets transmitted between the sending networking device and a receiving networking device.

14. The method of claim 8, further comprising:
upon determining that the ECN is not marked and that the measured delay is not less than the first threshold, determining whether the measured delay is greater than a second threshold, the second threshold being greater than the first threshold;
upon determining that the measured delay is greater than the second threshold, additively increasing the transmission parameter.

15. A system, comprising:
a receiving networking device; and
a sending networking device configured to use a multipath connection to transmit data over a network to the receiving networking device,
wherein the sending networking device is configured to:
determine whether an explicit congestion notification (ECN) is marked on an acknowledgement (ACK) received by the sending networking device, the ACK being associated with a packet transmitted from the sending networking device;
determine whether a measured delay associated with the packet is less than a target delay;
upon determining that the ECN is not marked and that the measured delay is less than the target delay, proportionally increase a transmission parameter based on a difference between the target delay and the measured delay;
wherein the target delay is associated with an average Round Trip Time (RTT) of packets transmitted between the sending networking device and the receiving networking device.

16. The system of claim 15, wherein the measured delay is based on a difference between an actual delay of the packet and a baseline delay of an uncongested network.

17. The system of claim 15, wherein the measured delay is based on a difference between a measured Round Trip Time (RTT) of the packet and a baseline RTT of an uncongested network.

18. The system of claim 15, wherein the transmission parameter is a congestion window size.

19. The system of claim 15, wherein the transmission parameter is a flow traffic's transmission rate.

20. The system of claim 15, wherein the sending networking device is further configured to:
upon determining that the ECN is not marked and that the measured delay is not less than the target delay, determine whether the measured delay is greater than at least two times of the target delay;
upon determining that the measured delay is greater than at least two times of the target delay, additively increase the transmission parameter.
